(19) United States
(12) Patent Application Publication
(10) Pub. No.: US 2015/0128033 A1
(43) Pub. Date: May 7, 2015

(54) METHOD AND APPARATUS FOR WEBPAGE BROWSING

(71) Applicant: TENCENT TECHNOLOGY (SHENZHEN) COMPANY LIMITED, Shenzhen (CN)

(72) Inventors: WEI LI, Shenzhen (CN); BO HU, Shenzhen (CN); TINGYONG TANG, Shenzhen (CN); YING HUANG, Shenzhen (CN); HUIJIAO YANG, Shenzhen (CN); KAI ZHANG, Shenzhen (CN); RUIYI ZHOU, Shenzhen (CN); XI WANG, Shenzhen (CN); YULEI LIU, Shenzhen (CN); XIN QING, Shenzhen (CN); ZHIPEI WANG, Shenzhen (CN); CHENG FENG, Shenzhen (CN); BOSEN HE, Shenzhen (CN); LEI GUAN, Shenzhen (CN); NING MA, Shenzhen (CN); HAO TANG, Shenzhen (CN); SIRUI LIU, Shenzhen (CN)

(73) Assignee: TENCENT TECHNOLOGY (SHENZHEN) COMPANY LIMITED

(21) Appl. No.: 14/592,250

(22) Filed: Jan. 8, 2015

Related U.S. Application Data
(63) Continuation of application No. PCT/CN2014/081833, filed on Jul. 8, 2014.

(30) Foreign Application Priority Data
Jul. 11, 2013 (CN) 2013-10291105.2

(51) Int. Cl. G06F 17/22; G06F 17/21; H04L 29/08

(52) U.S. Cl. CPC G06F 17/2247; H04L 67/10; G06F 17/2252; G06F 17/211
USPC 715/242; 715/234

(57) ABSTRACT

A webpage browsing method is provided. The method includes receiving a web address entered by a user for a webpage to be displayed on a terminal device and sending webpage request information containing the received web address to a server based on the received web address. The method also includes receiving webpage information corresponding to the web address returned from the server, where the webpage information includes images, videos, Flash animations, source files and styles. Further, the method includes performing operations for saving network traffic volume on the webpage information based on the received webpage information and displaying the processed webpage information in a web browser.

### CROSS-REFERENCES TO RELATED APPLICATIONS

This application is a continuation application of PCT Patent Application No. PCT/CN2014/081833, filed on Jul. 8, 2014, which claims priority of Chinese Patent Application No. 201310291105.2, filed on Jul. 11, 2013, the entire content of which is incorporated by reference herein.

### FIELD OF THE TECHNOLOGY

The present invention disclosure generally relates to the field of mobile terminal technologies and, more particularly, to methods and apparatuses for webpage browsing based on mobile terminal.

### BACKGROUND

With the development of Internet technologies, and the improvement in intelligence of personal computers (PCs) and mobile terminals (e.g., mobile phones, tablet PCs), more and more users use these terminals to access webpages. However, currently, because there are relatively more inline elements (e.g., images, videos, Flash animations, etc.) in the webpages, when the users browse the webpages, the webpage display speed is relatively slow and the network flow consumption is relatively high.

Especially for mobile terminal users, because the current webpages are generally designed for the personal computers, when the mobile terminals load the webpages, the loading process spends more CPU processing time, occupies more memory, and consumes more power and network flow, and the webpage display speed is slower.

The disclosed methods and apparatuses are directed to solve one or more problems set forth above and other problems.

### BRIEF SUMMARY OF THE DISCLOSURE

One aspect of the present disclosure includes a webpage browsing method. The method includes receiving a web address entered by a user for a webpage to be displayed on a terminal device and sending webpage request information containing the received web address to a server based on the received web address. The method also includes receiving webpage information corresponding to the web address, where the webpage information includes images, videos, Flash animations, source files and styles. Further, the method includes performing operations for saving network traffic volume on the webpage information based on the received webpage information and displaying the processed webpage information in a web browser.

Another aspect of the present disclosure includes a webpage browsing apparatus. The apparatus includes a web address receiving unit configured to receive a web address entered by a user for a webpage to be displayed on a terminal device and a web address sending unit configured to send webpage request information containing the received web address to a server based on the received web address. The apparatus includes a webpage information receiving unit configured to receive webpage information corresponding to the web address, where the webpage information includes images, videos, Flash animations, source files and styles. Further, the apparatus includes a processing unit configured to perform operations for saving network traffic volume on the webpage information and a display unit configured to display the webpage information processed by the processing unit in a web browser.

Other aspects of the present disclosure can be understood by those skilled in the art in light of the description, the claims, and the drawings of the present disclosure.

### BRIEF DESCRIPTION OF THE DRAWINGS

In order to describe the technical solution of the embodiments of the present invention more clearly, drawings used in the description of the embodiments are introduced below. The drawings described below are merely some exemplary embodiments of the present invention. For those skilled in the art, on the premise of no inventive effort being involved, other drawings may also be obtained according to these drawings and the descriptions included herein.

FIG. 1 illustrates a flow chart of an exemplary webpage browsing process consistent with the disclosed embodiments;

FIG. 2 illustrates a structure schematic diagram of an exemplary webpage browsing apparatus consistent with the disclosed embodiments;

FIG. 3 illustrates a structure schematic diagram of an exemplary mobile terminal consistent with the disclosed embodiments; and

FIG. 4 shows an environment incorporating certain aspects of the present invention.

### DETAILED DESCRIPTION

In the following description, for purposes of illustration, many specific details are illustrated in order to provide a full understanding of one or more embodiments. However, obviously, those embodiments can also be implemented in the case of these specific details changed, replaced, or alternated. The followings, together with accompanying drawings, describe in detail certain embodiments of the present invention.

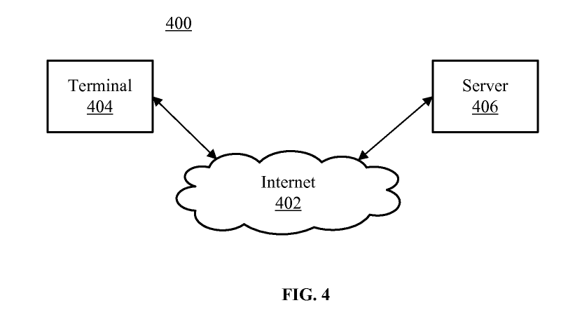

FIG. 4 shows an environment incorporating certain aspects of the present invention. As shown in FIG. 4, environment 400 may include a terminal device 404, a server 406, and the Internet 402. The terminal device (also known as the terminal) 404 may access the server 406 through the Internet 402 for certain personalized services provided by the server 406. Although only one server 406 and one terminal device 404 are shown in the environment 400, any number of terminal devices 404 or servers 406 may be included, and other devices may also be included.

The Internet 402 may include any appropriate type of communication network for providing network connections to the terminal device 404 and the server 406 or among multiple terminal devices 404 and servers 406. For example, Internet 402 may include the Internet or other types of computer networks or telecommunication networks, either wired or wireless.

A terminal device, as used herein, may refer to any appropriate user terminal with certain computing capabilities, such as a personal computer (PC), a work station computer, a server computer, a hand-held computing device (tablet), a smart phone or mobile phone, or any other user-side computing device. In certain embodiments, terminal device 404 may be a mobile terminal device, such as a smart phone, a tablet computer, or a mobile phone, etc. Terminal device 404 may be implemented on any appropriate computing platform.

A server, as used herein, may refer to one or more server computers configured to provide certain web server functionalities for webpage browsing. A server may also include one or more processors to execute computer programs in parallel. The server may store webpages to be access by terminal devices, and each of these webpages has a unique web address. The unique web address is also called Uniform Resource Locator (URL). For example, a user needs to enter a URL to browse a webpage to be displayed on the terminal device.

When accessing, the terminal device may request webpage information from the server. When such access is performed over a network where the user is charged based on network traffic volume, such as in a cellular network, the terminal device may perform certain functions to save the network traffic volume while browsing the webpages.

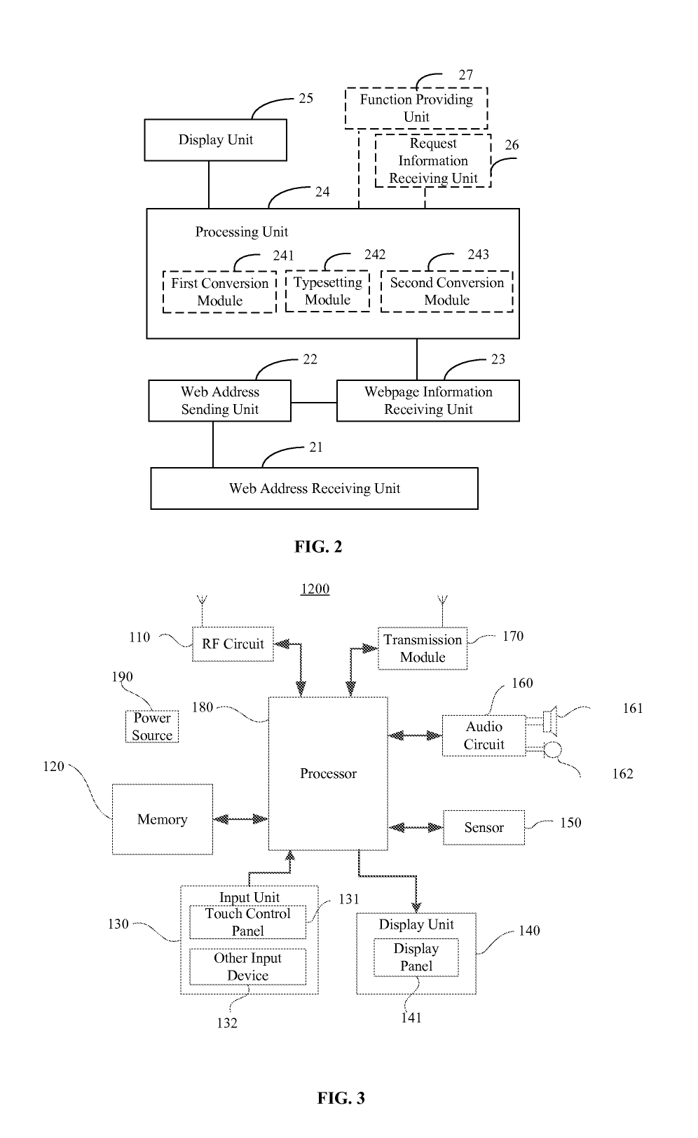

FIG. 3 illustrates a structure schematic diagram of an exemplary mobile terminal consistent with the disclosed embodiments. The mobile terminal may implement the webpage browsing process. As shown in FIG. 3, the mobile terminal 1200 may include a Radio Frequency (RF) circuit 110, a memory 120 containing at least one read only memory (only one shown in FIG. 3), an input unit 130, a display unit 140, a sensor 150, an audio circuit 160, a transmission module 170, a processor 180 containing at least one processor core (only one shown in FIG. 3), and a power source 190. A person skilled in the art may understand that the structure of the mobile terminal in FIG. 3 does not limit the mobile terminal, and more or fewer components than those shown may be included, or some components may be combined, or different component arrangement may be included.

The RF circuit 110 may be configured to receive and send electromagnetic waves and implement interconversion of electromagnetic waves and electrical signals, thus communicating with communication networks and other devices. The RF circuit 110 may include, but is not limited to, an antenna, a DSP (digital signal processor), a RF transceiver, an encryption/decryption chip, a Low Noise Amplifier (LNA), a duplexer, a subscriber identity module (SIM), and a memory. In addition, the RF circuit 110 may further communicate with various types of computer networks (e.g., Internet, Intranet, wireless network) or via wireless networks and other devices. The wireless networks may use any communication standard or protocol, which includes, but is not limited to, Global System of Mobile communication (GSM), Enhanced Data GSM Environment (EDGE), General Packet Radio Service (GPRS), Code Division Multiple Access (CDMA), Wideband Code Division Multiple Access CDMA (WCDMA), Long Term Evolution (LTE), Time Division Multiple Access (TDMA), Wireless Fidelity (Wi-Fi, e.g., IEEE 802.11a, IEEE 802.11b, IEEE 802.11g and/or IEEE 802.11n), Voice over Internet Protocol (VoIP), Worldwide Interoperability for Microwave Access (Wi-Max), and other protocols that can be used for Email, Instant Messaging (IM) and Short Messaging Service (SMS).

The memory 120 may be configured to store software programs and modules (e.g., program instructions and modules corresponding to the webpage browsing method and apparatus on the mobile terminal). The processor 180 executes all functional applications and data processing of the mobile terminal 1200 by running the software programs and the modules that are stored in the memory 120. That is, the function of saving network volume can be implemented during browsing the webpage on the mobile terminal.

The memory 120 may mainly include a program storage area and a data storage area. The program storage area may store an operating system, an application program required for at least one function (for example, a webpage browsing function), and so on. The data storage area may store data created according to use of the mobile terminal 1200. In addition, the memory 120 may include a high speed random access memory (RAM), and may further include a nonvolatile memory, for example, at least one disk storage device, at least one flash storage device, or other volatile solid state storage devices. The memory 120 may further include a remote memory relative to processor 180. The remote memory may connect to a mobile terminal 100 via a network.

The network may include, but is not limited to one or more portions of the Internet, an intranet, a wired Local Area Network (LAN), a wireless LAN (WiLAN), a Wide Area Network (WAN), a Metropolitan Area Network (MAN), Public Switched Telephone Network (PSTN) and other types of wired and wireless communications networks providing voice, video and data communications with wired or wireless communication protocols.

The input unit 130 may be configured to receive input number or character information and generate keyboard, mouse, joystick or trackball signal inputs related to user settings and function control of the mobile terminal 1200. Specifically, the input unit 130 may include a touch control panel 131 and another input device 132. The touch control panel 131 is also known as a touchscreen, may collect touch operations of a user on or near the touch control panel 131 (for example, a user operation on the touch control panel 131 or near the touch control panel 131 with any suitable object or accessory such as a finger and a stylus) and drive a corresponding connecting apparatus according to a preset program.

Optionally, the touch control panel 131 may include two parts, a touch detecting apparatus and a touch controller. The touch detecting apparatus detects a position of a user's touch and detects a signal generated by a touch operation, and transfers the signal to the touch controller. The touch controller receives touch information from the touch detecting apparatus, converts the touch information into touch-point coordinates, and then sends the touch-point coordinates to the processor 180. The touch controller can also receive an instruction sent from the processor 180 and execute the instruction. In addition, the touch control panel 131 may be implemented by using resistive, capacitive, infrared, surface sound wave types. In addition to the touch control panel 131, the input unit 130 may further include the other input device 132. Specifically, the other input device 132 may include, but is not limited to, one or more of a physical keyboard, a function button (such as a volume control button, and a switch button), a trackball, a mouse, and a joystick.

The display unit 140 may be configured to display information input by a user or information provided for a user and various graphic user interfaces (GUIs) of the mobile terminal 1200. The display unit 140 may include a display panel 141, and optionally, the display panel 141 may be configured in a form of a Liquid Crystal Display (LCD), an Organic Light-Emitting Diode (OLED). Further, the touch control panel 131 may cover the display panel 141. After detecting a touch operation on or near the touch control panel 131, the touch control panel 131 transfers the touch operation to the processor 180 to determine a type of a touch event. Then, the processor 180 provides a corresponding visual output on the display panel 141 according to the type of the touch event. Although the touch control panel 131 and the display panel 141 serve as two independent components to implement input and input functions of the mobile terminal 1200 in FIG. 3, in some embodiments, the touch control panel 131 and the display panel 141 may be integrated to implement the input and output functions of the mobile terminal 1200.

The mobile terminal 1200 may further include at least one sensor 150, for example, a light sensor, a motion sensor and other sensors. Specifically, the light sensor may include an ambient light sensor and a proximity sensor. The ambient light sensor may adjust brightness of the display panel 141 according to an intensity of ambient light rays. The proximity sensor may turn off the display panel 141 and/or backlight when the mobile terminal 1200 moves near an ear. As one type of motion sensor, an accelerator sensor may detect acceleration in each direction (generally three axes) and may detect magnitude and a direction of gravity when staying still, which may be used for applications for recognizing postures of a mobile terminal (for example, landscape and portrait switching, relevant games, magnetometer posture calibration), vibration recognition relevant functions (for example, pedometers and strikes), and so on. Other sensors such as a gyroscope, a barometer, a hygrometer, a thermometer, and an infrared sensor may also be configured on the mobile terminal 1200, which are not described in detail here.

The audio circuit 160, a loudspeaker 161, and a microphone 162 may provide an audio interface between a user and the mobile terminal 1200. The audio circuit 160 may convert received audio data into an electrical signal, and transmit the electrical signal to the loudspeaker 161, and the loudspeaker 161 converts the electrical signal into an audio signal for output. In another aspect, the microphone 162 converts a collected audio signal into an electrical signal. The audio circuit 160 receives the electrical signal, converts the electrical signal into audio data, and then outputs the audio data to the RF circuit 110, so as to send the audio data to another mobile terminal, or outputs the audio data to the memory 120 for further processing. The audio circuit 160 may also include an earphone jack to provide communications between a peripheral headset and the mobile terminal 1200.

The mobile terminal 1200 may help a user receive and send Emails, browse webpages, access stream media through the transmission module 170 (e.g., a Wi-Fi module). The transmission module 170 provides wireless broadband Internet access for the user. Although the transmission module 170 is shown in FIG. 3, it may be understood that, the transmission module 170 is not an essential component of the mobile terminal 1200, and may completely be omitted according to demands without changing the scope of the essence of the present disclosure.

The processor 180 is a control center of the mobile terminal 1200 and is connected to all parts of the entire mobile terminal through various types of interfaces and wires. By running or executing the software programs and/or the modules stored in the memory 120 and calling data stored in the memory 120, the processor 180 executes all functions and data processing of the mobile terminal 1200, so as to monitor the mobile terminal. The processor 180 may include one or more processor cores. Optionally, the processor 180 may integrate an application processor and a modem processor. The application processor mainly processes an operating system, user interfaces, application programs, and so on. The modem processor mainly processes wireless communication. It should be understood that the modem processor may also not be integrated in the processor 180.

The mobile terminal 1200 further includes the power source 190 (for example, a battery) for supplying power to each component. Optionally, the power source may be logically connected to the processor 180 through a power source management system, so as to implement functions such as managing charging, discharging, and power consumption through the power source management system. The power source 190 may include one or more DC or AC powers, recharging systems, power fail detection circuits, power supply converters or inverters, power status indicator, and any other components.

Though not shown in FIG. 3, the mobile terminal 1200 may further include a camera, a Bluetooth module, and so on, which are not described in detail here.

Specifically, the display unit of the mobile terminal can be a touch screen display device. The mobile terminal may also include a memory. One or more programs are stored in the memory. The one or more programs executed by one or more processors include instructions for performing certain webpage browsing processes.

For example, the mobile terminal 1200 (e.g., processor 180) receives a web address entered by a user and sends the web address to a server. The mobile terminal 1200 also receives webpage information corresponding to the web address returned from the server. Further, the mobile terminal 1200 performs operations for saving network traffic volume on the webpage information and displays the processed webpage information.

Further, the mobile terminal 1200 may also receive a request for starting network volume saving on the mobile terminal 1200. The request may include an instruction for saving network traffic sent by the user, or a trigger for saving network traffic generated based on a preset time interval or a network status change event.

Further, when performing the network volume saving operations, the mobile terminal 1200 and/or the server may convert the webpage information into a predefined format, and/or may load the webpage information sectionally, i.e., segment by segment or section by section, and typeset or render the loaded webpage information based on preset display parameters. The mobile terminal 1200 and/or the server may also obtain contents related to saving network traffic in the webpage information, and convert the obtained contents to contents meeting preset display rules.

The mobile terminal 1200 may also provide various functions in a graphics format for a user to select. The functions include a selection function for choosing network traffic saving modes. Further, the mobile terminal 1200 may receive the network traffic saving mode selected by the user, and performs network traffic saving operations on the webpage information based on the selected network traffic saving mode.

Thus, all functions related to saving network traffic in the browser are integrated together. When the user wants to browse the webpage in the network traffic saving mode, the user only needs to click one button to activate the network traffic saving operations for the webpage information. The user does not need to manually activate related functions in the browser or adjust settings, reducing operations of the user. In addition, based on individual browsing favorites, the user can also choose or customize the network traffic saving mode, meeting the individual needs of different users. When the terminal device loads the webpage in the network traffic saving mode, the CPU time and memory consumption are reduced, power and network flow consumption are also reduced, and the webpage display speed is improved.

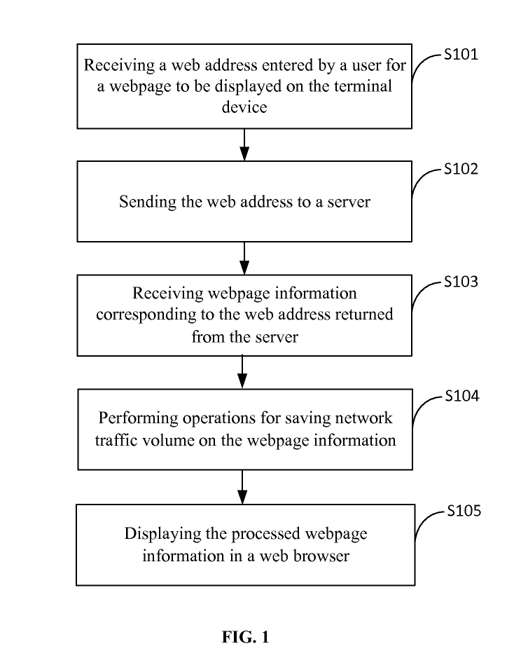

More specifically, FIG. 1 illustrates a flow chart of an exemplary webpage browsing process consistent with the disclosed embodiments. As shown in FIG. 1, the process may include the following steps.

S101: a terminal device receives a web address entered by a user for a webpage to be displayed on the terminal device.

The terminal device (e.g., a mobile terminal) receives the web address (or URL) entered by the user through an address bar in a web browser. The address bar (also known as a location bar or a URL bar) is a feature in the web browser that shows the current web address and accepts an entered web address that navigates the user to a chosen website. That is, the terminal device provides one address bar for the user, and the user can enter a URL of the requested webpage in the address bar and send the webpage request to the terminal device, where the webpage request carries the URL entered by the user.

The terminal device may also display a certain webpage containing one or more link addresses for the user. When the user clicks a link of another webpage in the current webpage, the terminal device receives a webpage request from the user, where the webpage request carries the link address (URL) of the webpage requested by the user.

S102: the terminal device sends the web address to a server.

Specifically, based on the received web address, the terminal device sends webpage request information to the corresponding server, where the webpage request information contains the received web address. For example, if a web address is “news.qq.com”, a terminal device sends webpage request information to a qq server (qq is an instant messaging software service which offers a variety of services, including online social games, music, shopping, microblogging, and group and voice chat.), where the request information contains “news.qq.com”.

S103: webpage information corresponding to the web address returned from the server is received.

The webpage information may include, but is not limited to, images, videos, Flash animations, source files (e.g., JavaScript source files), and styles (e.g., Cascading Style Sheets).

S104: operations for saving network traffic volume on the webpage information are performed, i.e., the network volume saving operations, before the webpage information is transmitted to the terminal device over, for example, a wireless communication network. Such operations may be performed by the terminal device, by the web server providing the webpage information, and/or by any intermediate server processing the webpage information.

The processing modes may include, but are not limited to, at least one of the followings.

A: the webpage information is converted to a predefined format, such as a Wireless Markup Language (WML) format. WML is a markup language intended for devices that implement the Wireless Application Protocol (WAP) specification, such as mobile phones. Transmission of WML documents requires less bandwidth compared to Hypertext Markup Language (HTML) documents because WML documents are simpler and WML is compressed before it is sent to the terminal device. Further, compared to HTML documents, displaying WML documents requires less processing power and memory. The webpage information converted into the WML format consumes less memory and CPU time of web browser comparing to the HTML format.

The terminal device may search WML documents corresponding to the HTML documents on the server, or may request WML documents from the server. The terminal device may also request the server to convert the HTML documents into the WML documents before sending.

B: the webpage information is loaded sectionally and the loaded webpage information is typeset or rendered sectionally based on preset display parameters. The preset display parameters may include, but are not limited to, display size (length and width), display resolution, and pixel density of the display screen of the terminal device. The display resolution is the number of distinct pixels in each dimension that can be displayed. The pixel density is the concentration of pixels on a particular display size and is measured in pixels per inch.

The terminal device may request the webpage information in segments or may request the server to send the webpage information in segments, such that the webpage information can be loaded sectionally.

C: contents related to network traffic saving in the webpage information is obtained, and the obtained contents are converted to contents meeting preset display rules.

The contents related to saving network traffic may include, but are not limited to, images, videos and Flash animations. The preset display rules may include, but are not limited to, converting the images to images with an image resolution matching a display resolution of the display screen of the terminal device and/or compressing the videos and the Flash animations.

The terminal device may request the server to perform such conversion before sending, and render the display on terminal device. Optionally, the terminal device may send the preset display parameters (e.g., display resolution, length and width of the display screen) to the server in advance. After the server receives the display parameters, the server rearrange the webpage information and sends the re-typeset webpage information to the terminal device.

Before performing S104, the terminal device may also receive a request for saving network traffic when browsing webpages.

For example, in practical applications, a start button for saving network traffic may be preset or a start instruction for saving network traffic is directly set (e.g., a clockwise or counterclockwise slide instruction on a touch screen). After receiving the start button clicked by the user or the start instruction sent by the user, or trigger information for saving network traffic, a function for saving network traffic is activated. That is, webpages are now browsed using the network traffic saving mode. The trigger information for saving network traffic may be generated based on a preset time interval or a network condition (e.g., a network status change), such as a switchover from a 3G network to a 2G network, or from a WIFI network (free of charge) to cellular network (charge based on network volume).

S105: the terminal device displays the processed webpage information in the web browser.

Specifically, the processed webpage information may be displayed on a new browser tab or a new browser window. The browser tab is webpage navigation displayed in the browser window.

It should be noted that a plugin or a tool that has a function for saving network traffic may be installed in advance in the browser of the terminal device, or installed directly in the terminal device as an independent plugin or tool. After receiving the above described starting request, the plugin or the tool runs on the backend of the terminal device (or in the background) to save network traffic volume for web browsing. The plugin or the tool integrates all functions related to network traffic volume saving in the browser.

Further, in order to meet the individual needs of users, before the terminal device performs the network volume saving operations, the process may also include the following step.

The terminal device provides various functions in a graphics format for the user to select. The functions include a selection function for choosing one or more network traffic saving modes as described above.

Specifically, the process for saving network traffic may include receiving the network traffic saving mode selected by the user, and performing the operations for saving network traffic based on the selected network traffic saving mode.

In one embodiment, after activating the function for saving network traffic, the webpage browsing effect may be affected due to the configuration for saving network traffic. For example, image quality may be reduced. Therefore, using the function provided for selecting the network traffic saving mode, the user can choose or customize the network traffic saving mode according to individual browsing favorites. For example, if a user prefers to browse a high-quality image, the user may select not to perform network volume saving operations for the images in the webpage information.

That is, a user interface is provided to the user to define individualized network traffic saving requirements to adjust different network traffic saving items. The terminal device can save the user requirement and also send such requirements to the server when browsing webpages on that server.

Thus, according to disclosed embodiments, a plugin or a tool can integrate all functions related to saving network traffic. When a user wants to browse webpages in a network traffic saving mode, the user only needs to click one button to activate the plugin or the tool. That is, the user does not need to manually turn on related functions or adjust settings in the browser.

Specifically, the plugin integrates the functions and settings related to saving network traffic, including adjusting image quality, converting a webpage format, re-typesetting a webpage, and compressing resources (e.g., images, videos, Flash animations). As long as the functions in the browser are related to saving network traffic, the functions can be integrated to the plugin. The user only needs to click one button, and then the plugin or the tool can automatically and quickly implement the default saving network traffic solutions.

When the plugin or the tool for saving network traffic is activated, the effect of webpage browsing may be impaired. For example, the image quality may not be as good as the image quality before the plugin or the tool for saving network traffic is activated. Based on the needs (e.g., image quality) of the user, the user may customize own plan for saving network traffic. All functions in the browser related to saving network traffic are integrated to provide a usable, efficient, and consistent user-defined interface. Therefore, the user can adjust functions related to saving network traffic.

By integrating all functions related to saving network traffic in the browser, when the user wants to browse the webpage in the network traffic saving mode, the user only needs to click one button to activate all operations for saving network traffic volume on the webpage. The user does not need to manually activate related functions in the browser or adjust settings, reducing operations of the user. In addition, based on individual browsing favorites, the user can also choose or customize the network traffic saving mode, meeting the individual needs of different users.

FIG. 2 illustrates a structure schematic diagram of an exemplary webpage browsing apparatus consistent with the disclosed embodiments. For illustration purposes, only related parts are illustrated herein.

The webpage browsing apparatus may be implemented in software, hardware, or a combination of software and hardware. The webpage browsing apparatus may also be an independent widget or distributed over different devices/systems, such as a terminal device and a server.

As shown in FIG. 2, the webpage browsing apparatus may include a web address receiving unit 21, a web address sending unit 22, a webpage information receiving unit 23, a processing unit 24, a display unit 25 and a request information receiving unit 26.

The web address receiving unit 21 is configured to receive a web address entered by a user. The web address sending unit 22 is configured to send the web address received by the web address receiving unit to a server. Further, the webpage information receiving unit 23 is configured to receive webpage information corresponding to the web address returned from the server.

The processing unit 24 is configured to perform operations for saving network traffic volume on the webpage information received by the webpage information receiving unit. The display unit 25 is configured to display the webpage information processed by the processing unit 24.

The request information receiving unit 26 is configured to receive a request for saving network traffic. The request information for saving network traffic may include an instruction for saving network traffic sent by the user or trigger information for saving network traffic generated based on a preset time interval or a network condition (e.g., a network status change), such as a switchover from a 3G network to a 2G network, or from a WIFI network (free of charge) to cellular network (charge based on network volume).

Further, as shown in FIG. 2, the processing unit 24 may include a first conversion module 241, a typesetting module 242 and a second conversion module 243.

The first conversion module 241 is configured to convert the webpage information to a predefined format. The typesetting module 242 is configured to load sectionally the webpage information, and typeset or render the loaded webpage information based on preset display parameters. That is, the content of the webpage information is re-arranged based on the processed information instead of in the original format.

The second conversion module 243 is configured to obtain contents related to network traffic saving in the webpage information, and convert the obtained contents to contents meeting preset display rules.

In addition, the webpage browsing apparatus may also include a function providing unit 27. The function providing unit 27 is configured to provide various functions in a graphics format for the user to select. The functions include a selection function for network traffic saving modes.

The processing unit 24 is further configured to receive the network traffic saving mode selected by the user, and perform operations for saving network traffic volume on the webpage information based on the selected network traffic saving mode.

It should be noted that, in the above webpage browsing apparatus, each functional unit is listed only for illustrative purposes. In practical applications, the above functions are implemented by different functional units and modules according to the needs. That is, the internal structure of webpage browsing apparatus is divided into different functional units to complete all or part of the functions described above.

Each functional unit in the embodiments of the present invention may be integrated into a processing module, or may be a separate physical unit. Alternatively, two or more than two functional units are integrated into one module. The above integrated modules may be implemented with hardware, or software function modules. Each of the above apparatuses may execute the methods in the method embodiments, which are not repeated herein.

The respective embodiments in the disclosure are described in a stepwise manner, the same or similar parts between the respective embodiments can be referred to with each other, and the emphasized explanations of the respective embodiments are the difference from other embodiments. Especially, for the apparatus embodiments, since they are substantially similar to the method embodiments, the description is comparatively simple, and relevant part can be referred to the explanation of the part of the method embodiments.

Those skilled in the art may implement the described functionality in varying ways for each particular application, but such implementation decisions should not be interpreted as being a departure from the scope of the present invention.

Those skilled in the art should understand that all or part of the steps in the above method may be executed by relevant hardware instructed by a program, and the program may be stored in a computer-readable storage medium such as a removable hard disk, a read-only memory (ROM), a random access memory (RAM), a magnetic disk, an optical disk, and so on.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and apparatuses for webpage browsing on a mobile terminal, when a user wants to browse a webpage in a network traffic saving mode, the user only needs to click one button to activate all operations for saving network traffic volume on the webpage. The user does not need to manually activate related functions in the browser or adjust settings, reducing operations of the user. In addition, based on individual browsing favorites, the user can also choose or customize the network traffic saving mode, meeting the individual needs of different users. Thus, the webpage browsing effect and the browsing experience of the user are improved.

What is claimed is:

1. A webpage browsing method, comprising:
receiving a web address entered by a user for a webpage to be displayed on a terminal device;
based on the received web address, sending webpage request information containing the received web address to a server;
receiving webpage information corresponding to the web address returned, wherein the webpage information includes images, videos, Flash animations, source files and styles;
based on the received webpage information, performing operations for saving network traffic volume on the webpage information; and
displaying the processed webpage information in a web browser.

2. The method according to claim 1, further including:
receiving a request for saving network traffic.

3. The method according to claim 2, wherein the request for saving network traffic includes one of the followings:
an instruction for saving network traffic sent by the user; and
a trigger for saving network traffic generated based on one of a preset time interval and a network condition.

4. The method according to claim 1, wherein performing operations for saving network traffic volume on the webpage information further includes at least one of the following modes:
converting the webpage information to a predefined format;
loading sectionally the webpage information and typesetting sectionally the loaded webpage information based on preset display parameters; and
obtaining contents related to network traffic saving in the webpage information and converting the obtained contents to contents meeting preset display rules.

5. The method according to claim 1, before performing operations for saving network traffic volume on the webpage information, further includes:
providing various functions in a graphics format for the user to define individualized network traffic saving requirements, wherein the functions include a selection function for choosing network traffic saving modes.

6. The method according to claim 5, wherein performing operations for saving network traffic volume on the webpage information further includes:
receiving the network traffic saving mode selected by the user; and
based on the selected network traffic saving mode, performing the operations for saving network traffic volume on the webpage information.

7. The method according to claim 4, wherein:
the predefined format is a wireless markup language (WML) format.

8. The method according to claim 4, wherein the preset display rules include at least one of the following rules:
converting the images to images with an image resolution matching a display resolution of a display screen of the terminal device; and
compressing the videos and the Flash animations.

9. A webpage browsing apparatus, comprising:
a web address receiving unit configured to receive a web address entered by a user for a webpage to be displayed on a terminal device;
a web address sending unit configured to send webpage request information containing the received web address to a server based on the received web address;
a webpage information receiving unit configured to receive webpage information corresponding to the web address returned, wherein the webpage information includes images, videos, Flash animations, source files and styles;
a processing unit configured to perform operations for saving network traffic volume on the webpage information; and
a display unit configured to display the webpage information processed by the processing unit in a browser.

10. The apparatus according to claim 9, further includes:
a request information receiving unit configured to receive a request for saving network traffic.

11. The apparatus according to claim 10, wherein the request for saving network traffic includes one of the followings:
an instruction for saving network traffic sent by the user; and
a trigger for saving network traffic generated based on one of a preset time interval and a network condition.

12. The apparatus according to claim 9, wherein the processing unit further includes:
a first conversion module configured to convert the webpage information to a predefined format;
a typesetting module configured to load sectionally the webpage information, and typeset sectionally the loaded webpage information based on preset display parameters; and
a second conversion module configured to obtain contents related to network traffic saving in the webpage information, and convert the obtained contents to contents meeting preset display rules.

13. The apparatus according to claim 9, further includes:
a function providing unit configured to provide various functions in a graphics format for the user to define individualized network traffic saving requirements, wherein the functions include a selection function for choosing network traffic saving modes.

14. The apparatus according to claim 13, wherein the processing unit is further configured to:
receive the network traffic saving mode selected by the user; and
based on the selected network traffic saving mode, perform the operations for saving network traffic volume on the webpage information.

15. The apparatus according to claim 12, wherein:
the predefined format is a wireless markup language (WML) format.

16. The apparatus according to claim 12, wherein the preset display rules include at least one of the following rules:
converting the images to images with an image resolution matching a display resolution of a display screen of the terminal device; and
compressing the videos and the Flash animations.
